(19) United States
(12) Patent Application Publication
(10) Pub. No.: US 2005/0110384 A1
(43) Pub. Date: May 26, 2005

(54) Lighting elements and methods

(76) Inventor: Charles M. Peterson, Sammamish, WA (US)

Correspondence Address: Ronald D. Trice;Office of Ronald D. Trice, 2101 Crystal Plaza Arcade # 138, Arlington, VA, 22202, US

(21) Appl. No.: 10/992,138

(22) Filed: Nov. 19, 2004

Related U.S. Application Data
(60) Provisional application No. 60/524,052, filed on Nov. 24, 2003.

(51) Int. Cl. H01J 5/48; H01J 5/50

(52) U.S. Cl. 313/318.01

(57) ABSTRACT

Lighting elements including organic light emitting devices (OLED) may be incorporated into incandescent, fluorescent, other conventional light bulbs and other lighting elements. Such lighting elements may be configured to produce colored or white light. The OLEDs may be fabricated from a plurality of polymers and/or include a plurality of chromophores.

### RELATED APPLICATIONS

This application claims priority from, and incorporates by reference, U.S. Provisional application Ser. No. 60/524,052, filed Nov. 24, 2003.

### FIELD OF THE INVENTION

The present invention relates generally to lighting elements with light emitters formed from organic semiconductor and more particularly, to lighting elements with light emitters formed from organic semiconductors that may be substituted for common lighting elements.

### BACKGROUND

Common lighting elements such as fluorescent and incandescent light bulbs can be found in every home and work place. Each light uses only a small amount of power. But, because lights are used for long periods of time and are used in huge numbers, the total energy used in aggregate is quite large. Accordingly, there is a need in the art to improve the energy efficiency of common lighting elements.

### SUMMARY OF THE INVENTION

An aspect of the present invention is to provide a light bulb including an organic light emitting device and an organic light emitting device housing, the housing including at least two electrical contacts. The housing and electrical contacts may be used in a non-organic light emitting device light bulb socket.

Another aspect of the present invention is to provide a light bulb including an organic light emitting device including a plurality of chromophores and an organic light emitting device housing. The housing including at least two electrical contacts. The housing and electrical contacts may be use in a conventional incandescent or fluorescent light bulb socket and wherein the organic light emitting device emits white light upon excitation.

Another aspect of the present invention is to provide a method of forming a light bulb including providing an organic light emitting device and housing the organic light emitting device in a housing including at least two electrical contacts. The housing and electrical contacts may be used in a non-organic light emitting device light bulb socket.

### BRIEF DESCRIPTION OF THE DRAWINGS

The invention will be described in detail with reference to the following drawings in which like reference numerals refer to like elements wherein:

FIG. 1 illustrates an OLED incandescent light bulb replacement;

FIG. 2 illustrates an OLED fluorescent light bulb replacement;

FIG. 3 illustrates an exemplary OLED lighting element;

FIG. 4 illustrates an exemplary structure of an OLED between two electrodes; and

FIG. 5 illustrates an OLED lighting element including stripes of red, blue and green emitting chromophores.

### DETAILED DESCRIPTION

The high conversion efficiency of some organic light emitting devices (OLED) may be use to save energy in common lighting applications. For example, the common incandescent light bulb and the common fluorescent light. Thus, lighting efficiency of common lighting fixtures may be improved by using an organic light emitting device (OLED Such OLED lighting elements may be configured such that they may be used in place of the common incandescent light bulb and the common fluorescent light so that existing lighting fixtures do not have to be modified or replaced. The spectrum of such lighting may be selected such that it produces white or colored light as desired by selecting the emitter materials of the OLED.

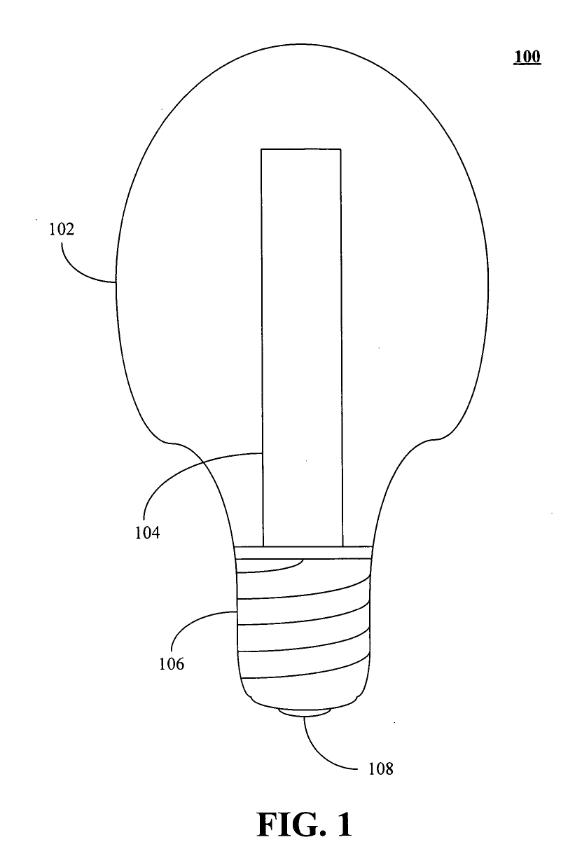

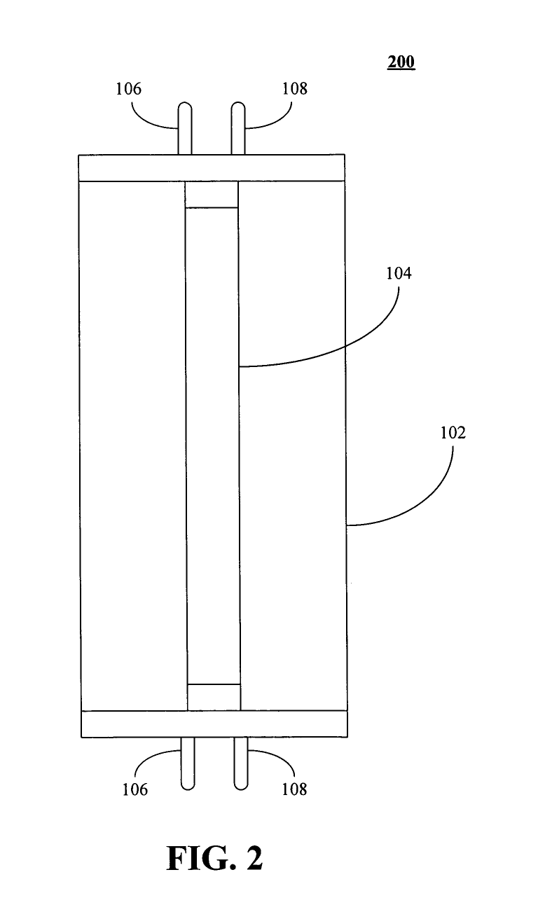

For example, FIG. 1 illustrates an OLED incandescent light bulb replacement 100 and FIG. 2 illustrates an OLED fluorescent light bulb replacement 200. Each of these replacements have an outer casing 102, an OLED lighting element 104, a first convention electrical contact 106 and a second convention electrical contact 108. The outer casing 102 may be clear (e.g., clear glass), frosted, diffusing, depolaring, colored (notch, band-pass, or having any other filtering spectrum), provide any other conventional function provided by light bulb outer casings 102 or may provide a combination of these functions. The OLED lighting element 104 may be any suitable OLED and may produce colored (including monochromatic) or white light by proper selection of OLED emitter materials. Alternatively, the OLED lighting element 104 may be fabricated as a separate element or may be fabricated on the outer casing 102. The OLED lighting element 104 may be a single element or multiple elements (for redundancy or for controlling the lighting level). The electrical contacts 106, 108 may be any conventional electrical contract.

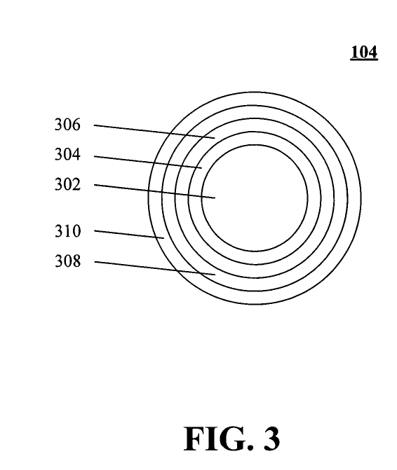

FIG. 3 illustrates an exemplary OLED lighting element 104. The OLED lighting element 104 includes a base 302, a reflective electrode 304, an OLED emitter layer 306, an at least partially transmissive electrode 308 and an optional outer layer 310. The base 302 may be any suitable material(s) or structure and may have any suitable shape. The reflective electrode 304 is deposited on the base 302 and is used to provide a first electrical connection to the OLED emitter layer 306 and to reflect light emitted by the OLED emitter layer 306 upon excitation. Alternatively, the base 302 and the reflective electrode 304 may be a single element. The reflective electrode 304 may be formed of a single material such as silver or may be formed of an alloy or any other suitable material or materials. Alternatively, the reflective electrode 304 could be made from a plurality of layers. The at least partially transmissive electrode 308 may be a transmissive material such as ITO or partially transmissive material such as a thin layer of silver. The at least partially transmissive electrode 308 may be formed from two or more layers such as thin layer of silver and a thicker coat of ITO. Additional conductive material may also be deposited upon the at least partially transmissive electrode 308 to improve the even application of current to the OLED emitter layer 306. The additional material may be opaque provided the additional material covers a small portion of the surface area. The optional outer layer 310 may be included to provide environmental protection, heat dissipation, frosted, diffusing, depolarizing, colored (notch, band-pass, or having any other filtering spectrum), provide any other conventional function provided by light bulb outer casings 102 or may provide a combination of these functions.

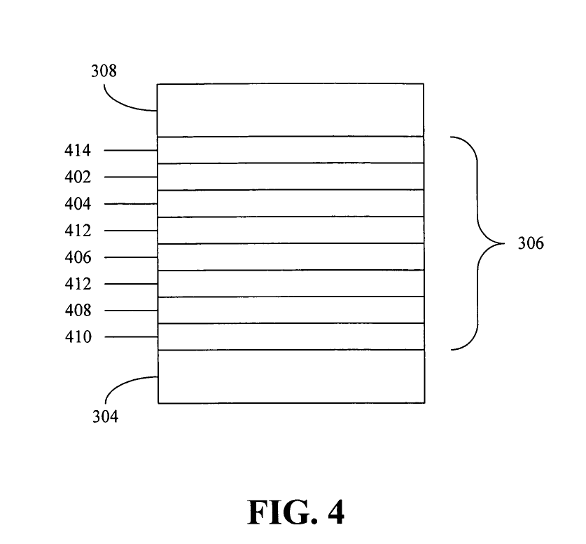

FIG. 4 illustrates an exemplary structure of an OLED emitter layer 306 between two electrodes 304, 308. This OLED emitter layer 306 includes a hole injection layer 402, hole transport layer 404, an emitter 406, an electron transport layer 408, an electron injection layer 410, and charge carrier blocker layers 412. The layers of the OLED emitter layer 306 may be produced one layer at a time any may be made from any suitable materials. For example, U.S. patent application Ser. Nos. 10/187,381, 10/187,402 and 10/187,396 which were respectively published as 2003/0119936, 2003/0099862 and 2003/0099785, respectively, describe certain exemplary materials that may be used to from the OLED emitter layer 306. These three published applications are hereby incorporated herein by reference. Another example may be found in U.S. Provisional Application 60/505,446, which discloses thienothiophene fused ring structural units with the non-conjugated diene and fluorene structural units, which is discussed in further detail below. This provisional application is hereby incorporated herein by reference. The three published applications and the one provisional application each disclose liquid crystalline materials that may be aligned and combined with other layers in the OLED emitter layer 306 which also may have aligned liquid crystalline order. The alignment of one of the layers of the OLED emitter layer 306 may result in subsequently formed layers with liquid crystal properties also being aligned. Such devices having aligned layers may be fabricated on a suitable alignment layer 414 and may include other elements not shown. Alternatively, some of these layers (including the alignment layer) may be omitted, a subset of adjacent layers may be built up according to this method, or subset of adjacent layers may be built up according to this method with some of the layers (including the alignment layer) being omitted.

The compounds of U.S. Provisional Application 60/505,446 combine thienothiophene fused ring structural units with the non-conjugated diene and fluorene structural units in the following general formula:
B₁—S₁-T₁-(F-T₂)ₚ-F-T₃-S₂—B₂ (General Formula 1)
wherein B₁ is a non-conjugated diene end group;
wherein B₂ is a non-conjugated diene end group;
wherein F is the fluorene functional unit has the formula of: 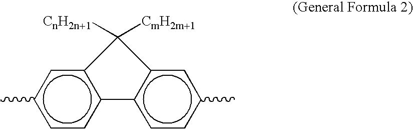
wherein n and m may be from 1 to 10;
wherein S₁ and S₂ are spacer units;
wherein at least one of T₁, T₂, and T₃ may have the formula:
   —W—X—Y— (General Formula 3);
wherein X may be chosen from amongst: 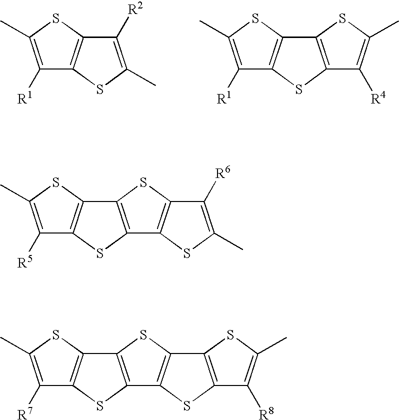
wherein W and Z may be chosen from amongst: 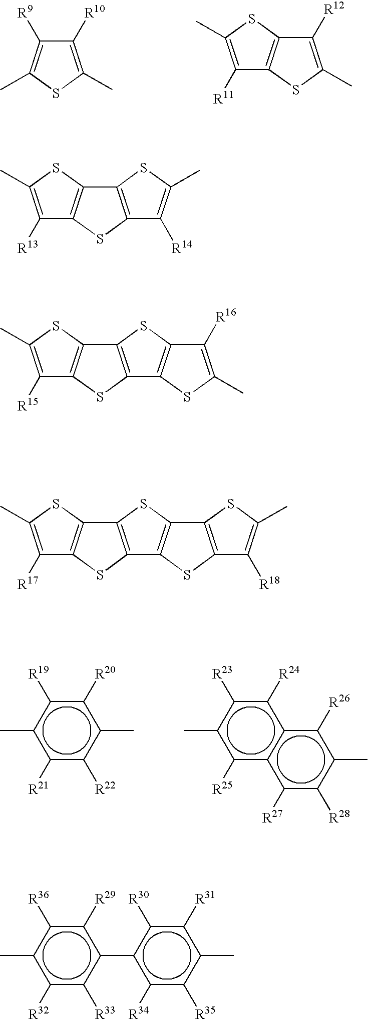
   or a single bond, and wherein R¹ through R³⁶ (if used) may be each independently be chosen from amongst H, halogen, CN, NO₂, or branched, straight chain, or cyclic alkyl groups with 1 to 12 carbon atoms, which are unsubstituted, or mono- or poly-substituted by F, Cl, Br, I, or CN or wherein one or more nonadjacent CH₂ groups may be replaced by —O—, —S—, —NH—, —NR—, —SiRR—, —CO—, —COO—, —OCO—, —OCO—O—, —S—CO—, —CO—S—, —CH═CH—, —C≡C— in such a manner that O and/or S atoms are not directly linked to each other;
wherein the T₁, T₂, and T₃ that do not have the general formula —W—X—Y— may be chosen from amongst a single bond or: 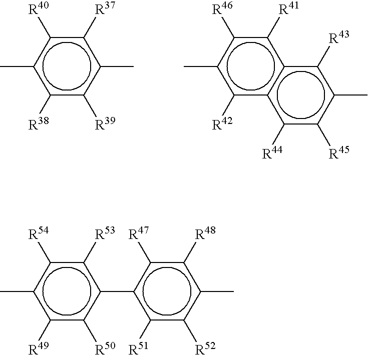
   or other aromatic or heteroaromatic diradicals wherein R³⁷ through R⁵³ (if used) may be each independently H, halogen, CN, NO₂, or branched, straight chain, or cyclic alkyl groups with 1 to 12 carbon atoms, which are unsubstituted, or mono- or poly-substituted by F, Cl, Br, I, or CN or wherein one or more nonadjacent CH₂ groups may be replaced by —O—, —S—, —NH—, —NR—, —SiRR—, —CO—, —COO—, —OCO—, —OCO—O—, —S—CO—, —CO—S—, —CH═CH—, —C≡C— in such a manner that O and/or S atoms are not directly linked to each other, and
wherein p=0 to 5.

The inclusion of the fluorene in the molecular structures leads to a decrease in the melting points of the reactive mesogens and also appears to stabilize the nematic phase relative to smectic phases.

The non-conjugated diene end group may be chosen from amongst: 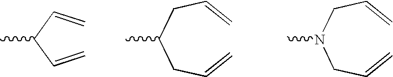
and have the advantage of very little shrinkage or photodegradation on photopolymerization. Of these three end groups, the 1,4-pentadiene end group appears to result in the least shrinkage and photodegradation.

Suitable spacer units (S₁ and S₂) include organic chains such as, for example, flexible aliphatic, amine, ester or ether linkages. The chains may be saturated or unsaturated and may be linear or branched. The presence of spacer groups aids the solubility and further lowers the melting point of the polymer which assists the spin coating thereof.

### THIENOTHIOPHENE EXAMPLE 1

The compound having the following formula: 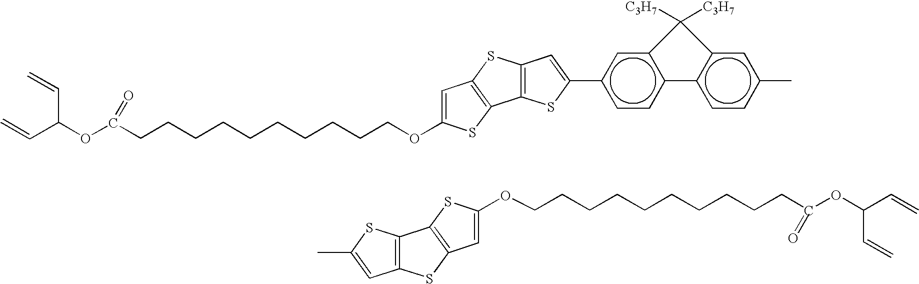
is a exemplary example of the compounds that may be prepared according to the present invention. This compound may be synthesized by the following steps:

Step 1:

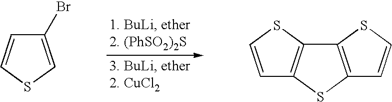

Step 2:

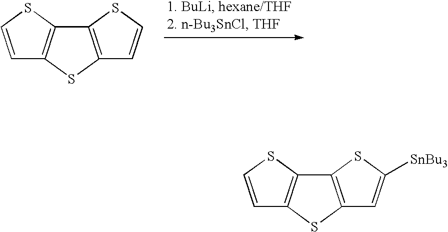

Additional explanation of steps 1 and 2 may be found in published US Patent Application No. 2003/0080322, which is incorporated herein by reference.

Step 3:

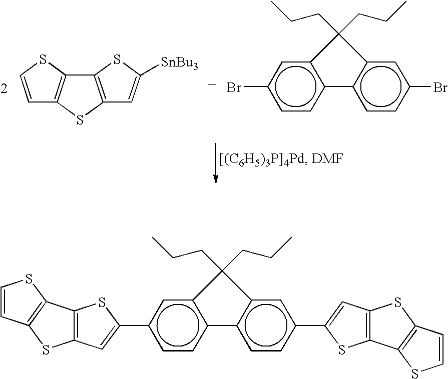

Step 3 is similar to the Stille arylation using 2-(tributylstannyl)thiophene similar to the Stille arylation using 2-(tributylstannyl)thiophene carried out in published US Patent Application No. 2003/0119936, which is incorporated herein by reference.

Step 4:

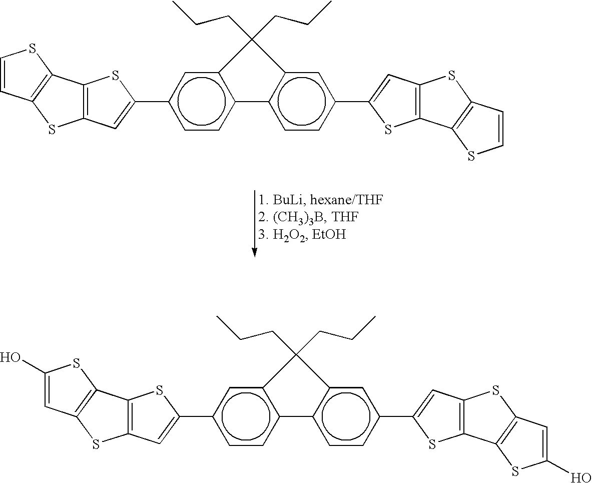

Further explanation of step 4 may be found in M. F. Hawthorne, J. Org. Chem 22, 1001 (1957), which is incorporated herein by reference.

Step 5: 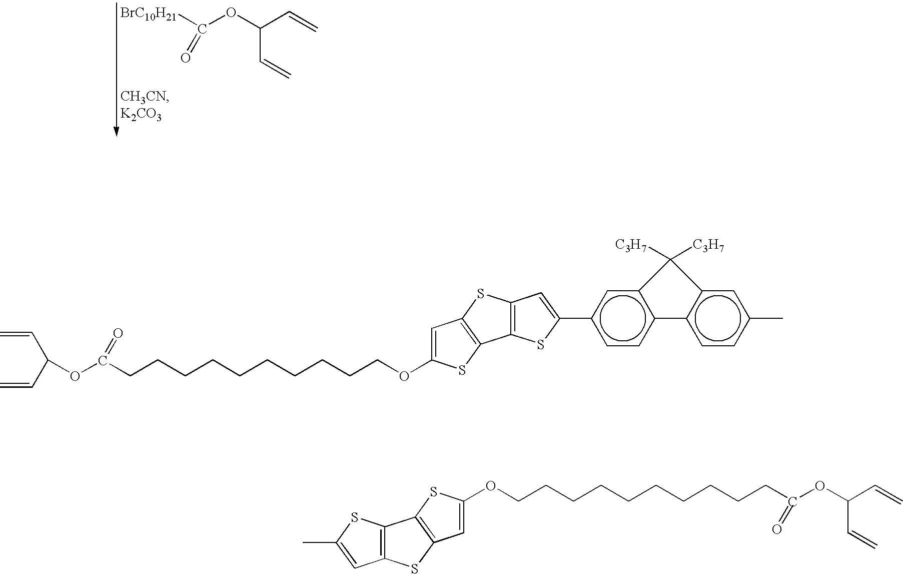
Step 5 is similar to the Williamson reaction run in US Patent Application 2003/0119936, which is incorporated herein by reference.

The material disclosed in U.S. patent application Ser. Nos. 10/187,381, 10/187,402 and 10/187,396, in U.S. Provisional Application 60/505,446, any other suitable alignable material, or any suitable unalignable material may be deposited and then crosslinked to form a crosslinked polymer network. By using a mixture of polymerizable (crosslinkable) materials instead of a single polymerizable material, the rate of polymerization may be increased. This increased polymerization rate facilitates room temperature fabrication in much shorter times and with much less energy being applied. This decrease in the energy being applied into the organic material decreases the amount of degradation produced by the polymerization process. Additionally, the use of a mixture may also improve the crosslinking density, may improve the quality or uniformity of alignment for alignable materials, and may improve the uniformity of the crosslinked polymer network.

For example, solvent solutions of binary or other mixtures of charge-transporting and/or light-emitting reactive mesogens with liquid crystalline phases (e.g., nematic or smectic phases) may be spin coated on a conducting photoalignment layer. The spin coating may be done at room temperature to form a film of liquid crystal either in a liquid crystalline phase that is thermodynamically stable at room temperature or in a supercooled liquid crystalline phase below its normal solid to liquid crystal phase transition temperature. Mixtures with thermodynamically stable liquid crystalline phases at room temperature have the advantage of lower viscosity and subsequent ease of crosslinking polymerization. The photoalignment layer aligns the reactive mesogen mixtures at room temperature on the substrate surface with the liquid crystalline director in the plane of the substrate such that one or more monodomains with planar orientation is formed. The charge injection and transport in the crosslinked polymer network is facilitated by the planar orientation. The presence of many different domains does not impair the charge injection and transport of the layers or the emission properties of devices containing such layers. The photoalignment layer may be irradiated by plane polarized UV light to create uniformly anisotropic surface energy at the layer surface. When the reactive mesogen mixture is subsequently coated on the photoalignment layer, the mixture and subsequent polymer network produced on crosslinking have a macroscopic monodomain. Additionally, the polymer network is insoluble and intractable which allows further layers with a different function to be deposited subsequently in a similar fashion.

The photoalignment layer may be used to align a layer of a mixture of reactive mesogens that becomes a polymeric hole transport layer with liquid crystalline order upon subsequent solvent casting on the photoalignment layer and crosslinking by exposure to UV radiation. Then a second layer of a mixture of reactive mesogens may be solvent cast on top of the hole transport layer. This second layer is aligned into a liquid crystalline monodomain by interaction with the aligned surface of the hole transport layer. The alignment of the second layer is believed to be achieved by molecular interactions between the molecules of the reactive mesogen materials at the interface between the two layers. The second reactive mesogen monolayer may now be crosslinked by exposure to UV radiation to form a polymeric emitter layer. Thus a series of organic semiconductor layers with liquid crystalline order may be built up with all of the molecular cores of the polymers oriented in the same direction.

If the polymerization process does not need an initiator, such as a photoinitiator, there will be no unreacted initiators to quench emission or degrade the performance and lifetime. For example, ionic photoinitiators may act as impurities in finished electronic devices and degrade the performance and lifetime of the devices.

If included, any suitable conducting photoalignment layer may be used. For example, the photoalignment layers described in published US application 20030021913 may be used. Alternatively, alignment may be achieved by any other suitable alignment layer or may be achieved without an alignment layer (e.g., the application of electric or magnetic fields, the application of thermal gradients or shear, surface topology, another suitable alignment technique or the combination of two or more techniques). However, rubbed alignment layers are not suitable for organic semiconductor layers and elements, such as the emitter layer in an organic light emitting device or semiconductor layers in integrated circuitry, because the organic layers and elements in such devices are thinner than the amplitude of the surface striations produced in alignment layers by rubbing. In some cases, the roughness resulting from the rubbing process has a thickness on the order of the thickness of the organic layers and elements. Additionally, diverse alignments may be imparted by an alignment layer(s) or technique(s). These diverse alignments may be in a pattern suitable for use in a pixelated device.

The crosslinking density of a network formed from a mixture of polymerizable monomers is higher than that of a network formed by the polymerization of the corresponding individual monomers. The increased crosslinking density may result because in formulating a mixture the solid to liquid crystal transition temperature is depressed below that of any of the individual components and may be depressed below room temperature. This means that the mixture has a thermodynamically stable liquid crystalline phase at room temperature and, as a result, has considerably reduced viscosity as compared to the supercooled glassy liquid crystalline phases of the individual components. This in turn means that reactive mesogen molecules are more mobile within the room temperature phase and thus are able to more quickly and more easily orient themselves to initiate the crosslinking reactions. Such anisotropic polymer network having a higher crosslinking density improves the performance of devices including layers, films or elements fabricated from the network and results in more stable devices.

### MIXTURE EXAMPLE 1

A binary mixture of 2,7-bis{4-[7-(1-vinylallyloxycarbonyl)heptyloxy]-4′-biphenyl}-9,9-dioctylfluorene mixed with 2,7-bis{4-[10-(1-vinylallyloxycarbonyl)decyloxy]-4′-biphenyl}-9,9-dioctylfluorene in a ratio of 1:3 (the mixture (mixture 1) has a low melting point (Cr—N=22° C.) and a high nematic clearing point (N—I=75° C.)) is coated on a quartz substrate and irradiated with unpolarized UV radiation from an argon ion laser. The laser emits 325 nm UV light and has a total fluence of 15 J cm⁻². The UV radiation causes photopolymerization of the diene end-groups without the use of a photoinitiator. The polymerization of the mixture is performed at room temperature (e.g., 25° C.) and uses an order of magnitude less radiation (e.g., 200 J cm⁻²) than is needed to polymerize the mixture component 2,7-bis{4-[10-(1-vinylallyloxycarbonyl)decyloxy]-4′-biphenyl}-9,9-dioctylfluorene in the glassy nematic state at the same temperature.

### MIXTURE EXAMPLE 2

A binary mixture of compound 1,2-(5-{4-[10-(1-vinyl-allyloxycarbonyl)-decyloxy]phenyl}thien-2-yl)-7-{4-[10-(1-vinyl-allyloxycarbonyl)decyloxy]-4′-biphenyl}-9,9-dipropylfluorene (1 part) and of compound II, 2-(5-{4-[10-(1-vinyl-allyloxycarbonyl)-decyloxy]phenyl}thien-2-yl)-7-{4-[10-(1-vinyl-allyloxycarbonyl)decyloxy]-4′-biphenyl}-9,9-dioctylfluorene (1 part) is a room temperature nematic liquid crystal mixture (mixture 2). This material may also be coated on to a quartz substrate and crosslinked with radiation from an argon ion laser as above. After crosslinking, the insoluble liquid crystalline polymer network has blue photoluminescence.

Mixture 2 has good hole transporting characteristics and may be used as a hole transporting layer in an organic light emitting device. For example, a 50 nm thick layer of mixture 2 may be cast by spin coating from chloroform on an ITO-coated glass substrate previously coated with a conductive photoalignment layer such as described in US Patent Application 2003/0099785. The room temperature nematic is homogenously aligned into a uniform layer by the photoalignment layer. Unpolarized irradiation by an argon ion laser at 325 nm with a total fluence of 15 J cm ⁻² may be used to crosslink the material. The irradiation may be carried out through a photomask if it is desired to pattern the hole transport layer. After exposure the layer may be washed with chloroform to remove uncrosslinked monomer.

Next a 50 nm layer of mixture 1 may be cast by spin coating from chloroform solution on top of the already fabricated hole transport layer fabricated from mixture 2. The room temperature nematic material of mixture 2 is homogenously aligned by intermolecular interactions at its interface with the hole transport layer. The nematic mixture 2 layer is irradiated with unpolarized 325 nm. UV radiation from an argon ion laser with a total fluence of 15 J cm⁻². This irradiation may also be carried out through a photomask to form a patterned emitter layer. As was described in Published US Patent Application 2003/0119936, the resulting multilayer assembly may be further assembled into a working organic light emitting device by vapour deposition of aluminium electrodes and hermetic packaging of the device.

The above mixtures and others may be found in U.S. patent application Ser. No. 10/632,430, which is incorporated herein by reference.

The above compounds and mixtures include chromophores. By selecting a single a single type of chromophore for inclusion into OLED lighting elements, colored or monochromatic OLED lighting elements may be fabricated. Alternatively, white OLED lighting elements may be fabricated by including a plurality of materials with different chromophores.

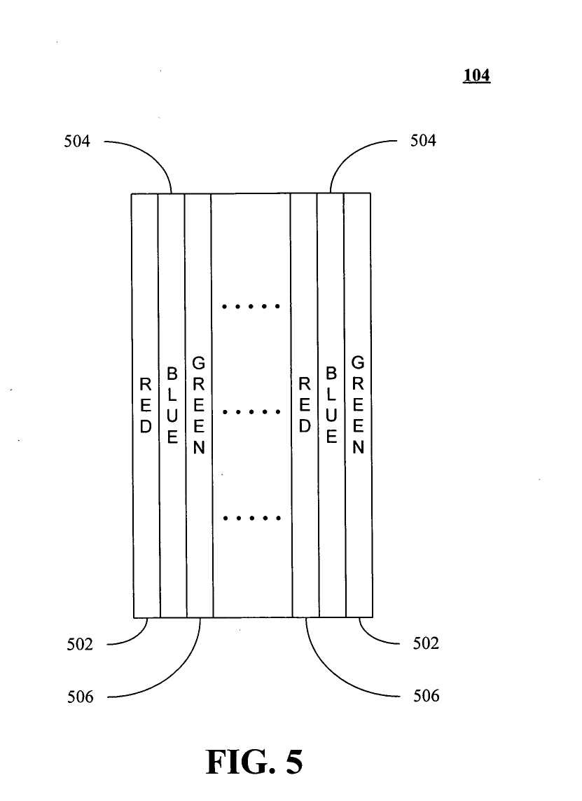

For example, FIG. 5 illustrates an OLED lighting element 104 including stripes of red emitting chromophores 502, blue emitting chromophores 504 and green emitting chromophores 506. By proper selection of materials and the relative areas of the stripes, white OLED lighting element 104 may be formed. Alternatively, the chromophores may be mixed together in suitable amounts such that a white OLED lighting element 104 may be formed. OLED lighting elements 104 that emit light of any desired spectrum may be formed by combining different chromophores. The spectrum may be altered through filtering through a colored glass or other filter or by any other suitable means.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

1. A light bulb comprising:
an organic light emitting device; and
an organic light emitting device housing, the housing including at least two electrical contacts,
wherein the housing and electrical contacts may be use in a non-organic light emitting device light bulb socket.

2. The light bulb of claim 1, wherein the non organic light emitting device light bulb socket is a conventional incandescent or fluorescent light bulb socket.

3. The light bulb of claim 1, wherein the organic light emitting device emits white light upon excitation.

4. The light bulb of claim 1, wherein the organic light emitting device emits colored light upon excitation.

5. The light bulb of claim 1, wherein the organic light emitting device includes a plurality of chromophores.

6. The light bulb of claim 5, wherein the organic light emitting device emits white light upon excitation.

7. A light bulb comprising:
an organic light emitting device including a plurality of chromophores; and
an organic light emitting device housing, the housing including at least two electrical contacts,
wherein the housing and electrical contacts may be use in a conventional incandescent or fluorescent light bulb socket, and
wherein the organic light emitting device emits white light upon excitation.

8. A method of forming a light bulb comprising:
providing an organic light emitting device; and
housing the organic light emitting device in a housing including at least two electrical contacts,
wherein the housing and electrical contacts may be use in a non-organic light emitting device light bulb socket.

9. The method of claim 8, wherein the non organic light emitting device light bulb socket is a conventional incandescent or fluorescent light bulb socket.

10. The method of claim 8, wherein the organic light emitting device emits white light upon excitation.

11. The method of claim 8, wherein the organic light emitting device emits colored light upon excitation.

12. The method of claim 8, wherein the organic light emitting device includes a plurality of chromophores.

13. The method of claim 8, wherein the organic light emitting device emits white light upon excitation.
